(19) United States
(12) Patent Application Publication
(10) Pub. No.: US 2018/0241139 A1
(43) Pub. Date: Aug. 23, 2018

(54) ELECTRICAL TERMINAL ASSEMBLY AND METHOD OF ASSEMBLING THE SAME

(71) Applicant: Lear Corporation, Southfield, MI (US)

(72) Inventor: Albert Cabanero, Cebu City (PH)

(21) Appl. No.: 15/440,851

(22) Filed: Feb. 23, 2017

(51) Int. Cl. H01R 4/70; H01R 4/18; H01R 43/16; H01R 43/048

(52) U.S. Cl. CPC H01R 4/70; H01R 43/048; H01R 43/16; H01R 4/185

(57) ABSTRACT

An electrical terminal assembly includes an electrical conductor, a terminal, and an expanding seal connected to the electrical conductor and the terminal. The electrical conductor may include at least one of a wire and a cable. The expanding seal may be is configured to expand when exposed to liquid. The expanding seal may include a hydrophilic material.

### TECHNICAL FIELD

The present disclosure relates to electrical components, including electrical connectors and/or electrical terminals.

### BACKGROUND

This background description is set forth below for the purpose of providing context only. Therefore, any aspects of this background description, to the extent that it does not otherwise qualify as prior art, is neither expressly nor impliedly admitted as prior art against the instant disclosure.

Assembly of electrical terminal assemblies may differ from one electrical terminal assembly to the next. Differences between terminal assemblies, such as differences in the configuration and/or material of a seal or conductor used, may lead to performance or quality issues. Using seals of many different sizes for different sizes of terminals or conductors may not be efficient.

There is therefore a desire for solutions/options that minimize or eliminate one or more of the above-described challenges. The foregoing discussion is intended only to illustrate examples of the present field and should not be taken as a disavowal of scope.

### SUMMARY

In embodiments, an electrical terminal assembly includes an electrical conductor, a terminal, and/or an expanding seal that may be connected to the electrical conductor and the terminal. The electrical conductor may include at least one of a wire and a cable. The expanding seal may be configured to expand when exposed to liquid and/or moisture. The expanding seal may include a hydrophilic material. The expanding seal may include a plurality of radially-extending ribs that may be configured to create a sealing interface with a connector.

With embodiments, an electrical terminal assembly may include a second electrical conductor, a second terminal, and/or a second expanding seal. The second expanding seal may be connected with the second electrical conductor and/or the second terminal. An outer diameter of the electrical conductor may be larger than an outer diameter of the second electrical conductor. An inner diameter of the expanding seal may be substantially the same as an inner diameter of the second expanding seal. The outer diameter of the electrical conductor may be at least 1.5 times larger than the outer diameter of the second electrical conductor. The outer diameter of the electrical conductor may be at least two times larger than the outer diameter of the second electrical conductor. The terminal and/or the second terminal may be disposed at least partially in a connector such that the expanding seal provides a first sealing interface with the connector and/or the second expanding seal provides a second sealing interface with the connector.

In embodiments, a method of assembling an electrical terminal assembly may include providing an electrical conductor, providing a terminal, providing an expanding seal, and/or crimping the terminal, the electrical conductor, and the expanding seal together to create a crimped terminal. The method may include expanding the expanding seal. Expanding the seal may include exposing the seal to a liquid and/or moisture, which may include water. The expanding seal may include a hydrophilic material. The expanding seal may include a hydrophilic rubber. One or more gas pockets may be disposed between the terminal and the conductor of the crimped terminal. The method may include filling the gas pockets by expanding the expanding seal. The expanding seal may include a plurality of radially-extending ribs that may be configured to create a sealing interface with a connector and/or may include a plurality of air gaps that may be disposed between the plurality of radially-extending ribs. Expanding the expanding seal may include reducing sizes of the plurality of air gaps. During expansion, areas of the expanding seal between the plurality of radially-extending ribs may expand to a greater degree than the plurality of radially-extending ribs. The method may include providing a second electrical conductor, providing a second terminal, providing a second expanding seal, and/or connecting the second terminal, the second conductor, and the second expanding seal together. An outer diameter of the electrical conductor larger than an outer diameter of the second electrical conductor, and an inner diameter of the expanding seal is substantially the same as an inner diameter of the second expanding seal. The outer diameter of the electrical conductor may be at least 1.5 times larger than the outer diameter of the second electrical conductor.

### BRIEF DESCRIPTION OF THE DRAWINGS

FIG. 1 is a perspective view of an embodiment of an electrical terminal assembly in accordance with teachings of the present disclosure.

FIGS. 2 and 3 are cross-sectional views of embodiments of electrical terminal assemblies including connectors in accordance with teachings of the present disclosure.

FIG. 4 is a perspective view of an embodiment of an electrical terminal assembly including a connector in accordance with teachings of the present disclosure.

### DETAILED DESCRIPTION

Reference will now be made in detail to embodiments of the present disclosure, examples of which are described herein and illustrated in the accompanying drawings. While the disclosure will be described in conjunction with embodiments and/or examples, it will be understood that they are not intended to limit the present disclosure to these embodiments and/or examples. On the contrary, the present disclosure is intended to cover alternatives, modifications, and equivalents, which may be included within the spirit and scope of the present disclosure.

Electrical terminals may be used with conductors, such as wires, and may be connected to wires in one or more of a variety of ways. For example, and without limitation, electrical terminals may be crimped with wires that may include cross-sectional areas of about 0.5 mm² to 2.0 mm² (e.g., with outer diameters of about 0.4 mm to about 0.7 mm) or other larger or smaller wires. Seals used with relatively small wires (e.g., about 0.5 mm²) may not be compatible with larger wires (e.g., about 1.5 mm²), so, in some designs, a plurality of seals of different sizes (e.g., with different internal bore diameters) may be used for different sizes of wires. Using a plurality of seals of different sizes may present certain manufacturing/assembly challenges. For example, and without limitation, storing and organizing different seals that may be used with different sizes of terminals for the same connector may be more complicated and/or inadvertent use of the wrong size of seal may result in poor sealing. Over time, an incorrect seal may unseat, such as due to vibration.

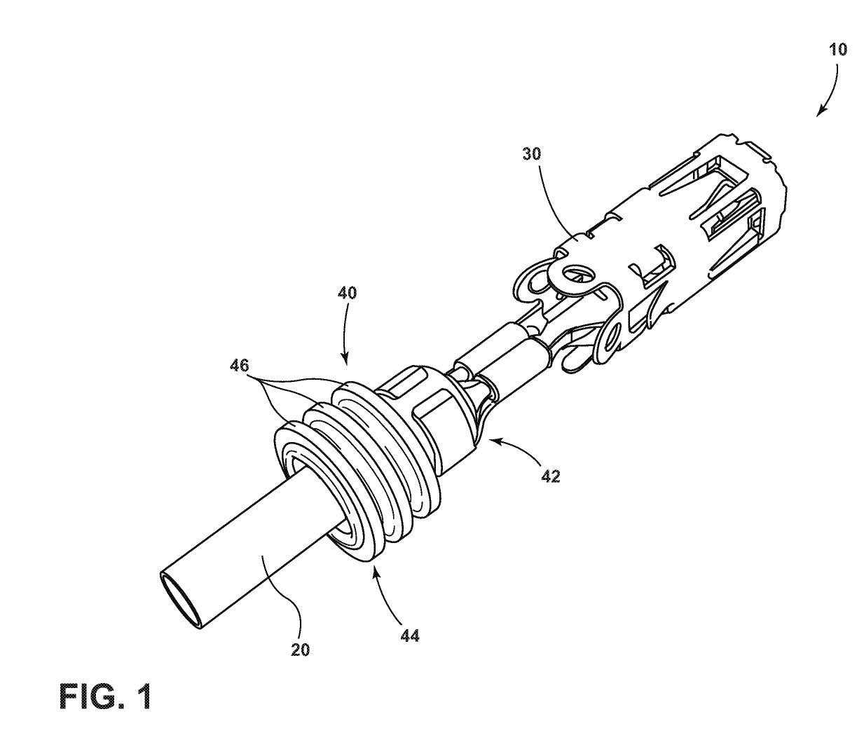

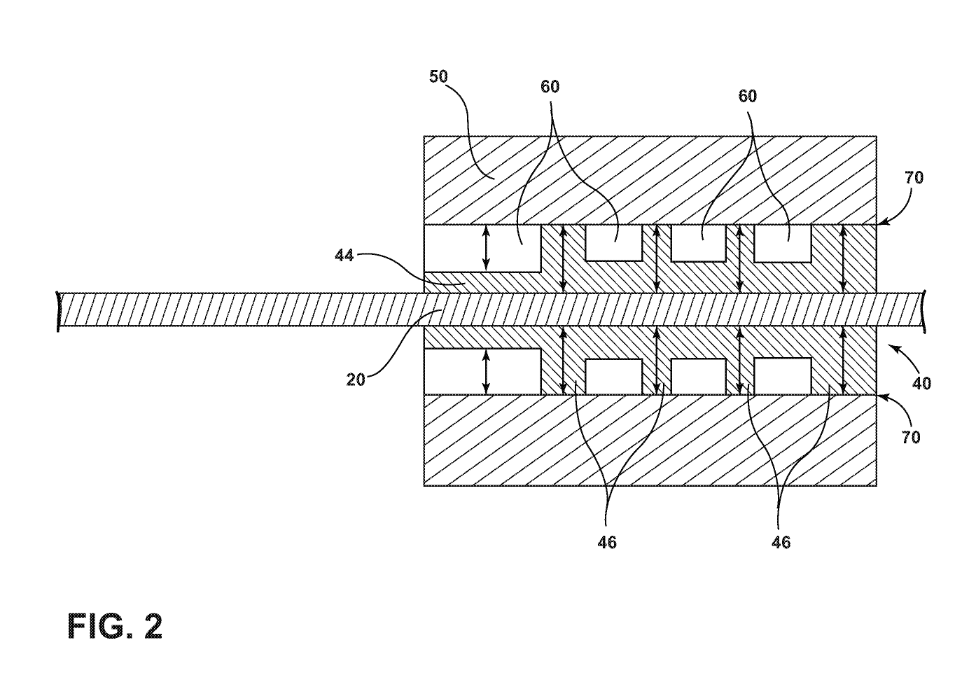

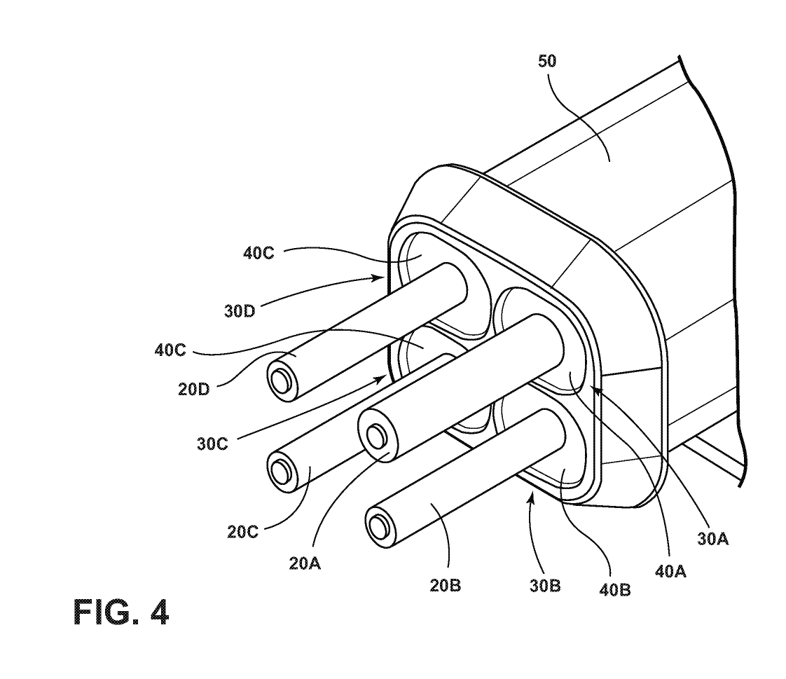

In embodiments, such as generally illustrated in FIGS. 1-3, an electrical terminal assembly 10 may include a conductor 20, a terminal 30, and/or a seal 40. Conductor 20 may include an electrical conductor and/or may be configured for allowing the flow of electrical current, such as a wire or cable. Conductor 20 may be included in a wiring harness, such as a vehicle wiring harness. Terminal 30 may include an electrically conductive material and/or may be configured for allowing the flow of electrical current. Terminal 30 may be electrically and/or physically connected with conductor 20. For example, and without limitation, terminal may be crimped with conductor 20. As generally illustrated in FIG. 2-4, terminal assembly 10 may be configured for connection with and/or include a connector 50, such as a wiring harness connector. Connector 50 may be configured for connection with an electrical component or device, such as an electronic actuator, a sensor, a power distribution unit, and/or an electrical junction box.

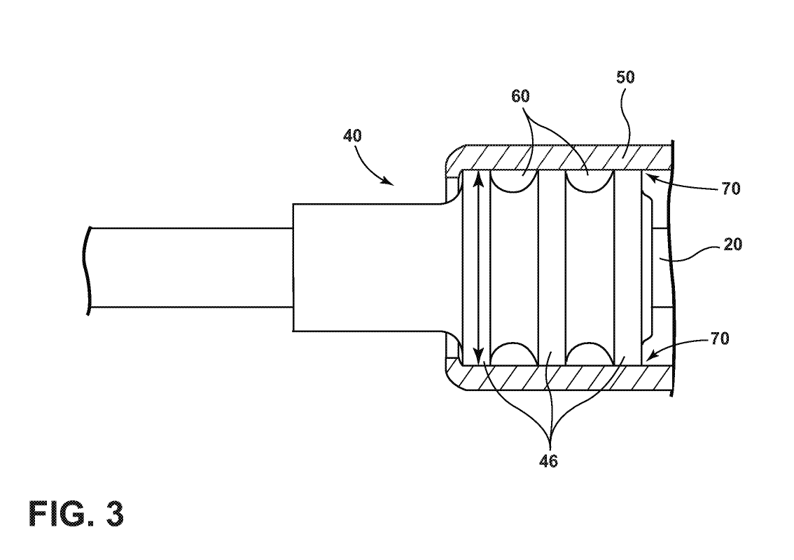

With embodiments, seal 40 may be connected with conductor 20, terminal 30, and/or connector 50, and may be configured to restrict/prevent liquid or moisture from entering connector 50 and/or from contacting conductor 20. For example, and without limitation, seal 40 may be connected (e.g., crimped) with conductor 20 and terminal 30. Seal 40 may include one or more of a variety of shapes, sizes, configurations, and/or materials. For example, and without limitation, seal 40 may be configured to expand and/or may include a material with one or more characteristics that may change if exposed to liquid, such as a hydrophilic material. Seal 40 may include, for example, hydrophilic rubber. In embodiments, seal 40 may expand, such as if seal 40 is exposed to a liquid (see, e.g., arrows in FIGS. 2 and 3). Seal 40 may expand radially and/or axially, for example. Expansion of seal 40 may improve the ability of seal 40 to restrict/prevent moisture from entering connector 50 and/or from contacting conductor 20 (e.g., expansion may fill/minimize gaps 60 that may be present in a crimped terminal and/or between a crimped terminal 30 and connector 50). For example, and without limitation, after terminal 30 is connected/engaged (e.g., crimped) with conductor 20 and expanding seal 40, and/or is inserted into a connector 50, one or more fluid (e.g., air) gaps or pockets 60 may be disposed between conductor 20, terminal 30, and/or connector 50 (e.g., that expanding seal 40 did not initially fill). Expansion of expanding seal 40 may include at least partially filling fluid gaps or pockets 60 with seal 40, which may further reduce the potential for liquid entering the crimped terminal.

In embodiments, expanding seal 40 may include a first section 42 and/or a second section 44. First section 42 may be configured to be pressed or crimped, such as with and/or between conductor 20 and terminal 30. Second section 44 may be disposed adjacent to first section 42 and/or may be configured to cooperate with a connector 50 to provide a sealing interface 70. With embodiments, second section 44 may include one or more radially-extending ribs 46 that may be configured to engage and/or contact a connector 50 and may be configured to provide sealing interface 70 with connector 50. For example, and without limitation, second section 44 may include four ribs 46 (see, e.g., FIG. 2) in a first embodiment and second section 44 may include three ribs 46 (see, e.g., FIGS. 1 and 3) in a second embodiment. Some or all of ribs 46 may include different widths (e.g., measured in axial direction).

In embodiments, one or more air gaps or pockets 60 may be disposed between adjacent ribs 46. Seal 40 may include a generally cylindrical configuration and ribs 46 may extend around all or part of the circumference of seal 40. If seal 40 expands (e.g., if it is exposed to liquid), areas of seal 40 between ribs 46 may expand (e.g., radially outward) to a greater degree than ribs 46. If seal 40 expands, the size (e.g., volume) of air gaps or pockets 60 may decrease.

With embodiments, such as generally illustrated in FIGS. 2-4, an electrical terminal assembly 10 may include a connector 50. One or more terminals 30 may be connected with connector 50. For example, and without limitation, a first terminal 30A, a second terminal 30B, a third terminal 30C, and/or a fourth terminal 30D may be connected with a connector 50. First terminal 30A may be connected with a first conductor 20A and a first expanding seal 40A. Second terminal 30B may be connected with a second conductor 20B and a second expanding seal 40B. Third terminal 30C may be connected with a third conductor 20C and a third expanding seal 40C. Fourth terminal 30D may be connected with a fourth conductor 20D and a fourth expanding seal 40D. Outer diameters of first conductor 20A, second conductor 20B, third conductor 20C, and/or fourth conductor 20D may or may not be substantially equal. For example, and without limitation, an outer diameter (e.g., a maximum diameter) of first conductor 20A may be larger than an outer diameter of second conductor 20B (e.g., 1.5 or 2 or more times larger). However, inner diameters (e.g., initial/pre-expansion minimum inner diameters) of first expanding seal 40A and second expanding seal 40B may be substantially equal (e.g., expanding seals 40 with the same configuration may be used with conductors 20 of significantly different sizes).

With embodiments, a method of assembling an electrical terminal assembly 10 may include providing an electrical conductor 20, providing a terminal 30, providing an expanding seal 40, and/or connecting/crimping terminal 30 with electrical conductor 20. Crimping terminal 30 with electrical conductor 20 may create a crimped terminal. At least a portion of expanding seal 40 (e.g., first section 42) may be crimped with and/or disposed between electrical conductor 20 and terminal 30 of the crimped terminal. The method may include inserting at least a portion of the crimped terminal into a connector 50, which may include inserting some or all of expanding seal 40 into connector 50. Connector 50 may be used in connection with, for example, a wiring harness. The method may include expanding the expanding seal 40, such as via exposing the seal 40 to a liquid. The liquid may include water, for example. In embodiments, prior to expanding the expanding seal 40, one or more air gaps or pockets 60 may be disposed between conductor 20, terminal 30, and/or connector 50. Expanding a seal 40 may fill and/or reduce the volume of one or more of the air gaps or pockets 60. The air gaps or pockets 60 may include one or more of a variety of configurations and may or may not each be the same. For example, and without limitation, air gaps or pockets 60 may include an initial shape that may be generally rectangular and/or that may be rounded near seal 40 (e.g., may include a generally hemispherical cross section).

In embodiments, if expanding seal 40 has expanded, such as due to exposure to a liquid, expanding seal 40 may return to its original size, or at least a smaller size, if less liquid or no liquid is present (e.g., if the liquid evaporates).

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It should be understood that references to a single element are not so limited and may include one or more of such element. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” throughout the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are intended to be inclusive unless such a construction would be illogical.

It is intended that all matter contained in the above description or shown in the accompanying drawings shall be interpreted as illustrative only and not limiting. Changes in detail or structure may be made without departing from the present disclosure.

Furthermore, the mixing and matching of features, elements and/or functions between various examples is expressly contemplated herein so that one of ordinary skill in the art would appreciate from this disclosure that features, elements, and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification, but that the scope of the present disclosure will include any embodiments falling within the foregoing description and the appended claims.

1. An electrical terminal assembly, comprising:
an electrical conductor;
a terminal; and
an expanding seal connected to the electrical conductor and the terminal,
wherein the expanding seal includes rubber and the expanding seal is configured to expand when exposed to liquid.

2. (canceled)

3. (canceled)

4. The electrical terminal assembly of claim 1, wherein the expanding seal includes a hydrophilic material.

5. The electrical terminal assembly of claim 1, wherein the expanding seal includes a plurality of rounded pockets and a plurality of radially-extending ribs configured to create a sealing interface with a connector; wherein an outer portion of at least one of the plurality of radially-extending ribs is substantially flat.

6. The electrical terminal assembly of claim 1, including a second electrical conductor, a second terminal, and a second expanding seal, wherein the second expanding seal is connected with the second electrical conductor and the second terminal, an outer diameter of the electrical conductor is larger than an outer diameter of the second electrical conductor, and an inner diameter of the expanding seal is substantially the same as an inner diameter of the second expanding seal.

7. The electrical terminal assembly of claim 6, wherein the outer diameter of the electrical conductor is at least 1.5 times larger than the outer diameter of the second electrical conductor.

8. (canceled)

9. (canceled)

10. A method of assembling an electrical assembly, the method comprising:
providing an electrical conductor;
providing a connector;
providing an expanding seal; and
connecting the connector, the electrical conductor, and the expanding seal together such that the expanding seal is connected to the electrical conductor and the connector.

11. The method of claim 10, comprising expanding the expanding seal.

12. The method of claim 11, wherein expanding the expanding seal includes exposing the expanding seal to a liquid.

13. (canceled)

14. The method of claim 10, wherein the expanding seal includes a hydrophilic material.

15. The method of claim 14, wherein the expanding seal includes a hydrophilic rubber.

16. The method of claim 10, wherein one or more fluid pockets are disposed between the connector and the electrical conductor.

17. The method of claim 16, comprising filling the fluid pockets by expanding the expanding seal.

18. The method of claim 11, wherein the expanding seal includes a plurality of radially-extending ribs configured to create a sealing interface with a connector and a plurality of air gaps disposed between the plurality of radially-extending ribs; expanding the expanding seal includes reducing sizes of the plurality of air gaps; and, during expansion, areas of the expanding seal between the plurality of radially-extending ribs expand to a greater degree than the plurality of radially-extending ribs.

19. The method of claim 10, including:
providing a second electrical conductor;
providing a second terminal;
providing a second expanding seal; and
connecting the second terminal, the second electrical conductor, and the second expanding seal together,
wherein an outer diameter of the electrical conductor is larger than an outer diameter of the second electrical conductor, and an inner diameter of the expanding seal is substantially the same as an inner diameter of the second expanding seal.

20. (canceled)

21. The electrical terminal assembly of claim 1, wherein the expanding seal includes a radially-extending rib and a neck portion; and a diameter of the neck portion is less than a diameter of the radially-extending rib.

22. The electrical terminal assembly of claim 1, wherein the expanding seal includes a neck portion, a pocket, and a radially-extending rib; and the neck portion includes an axial width greater than at least one of an axial width of the pocket and the axial width of the radially-extending rib.

23. The electrical terminal assembly of claim 1, wherein the expanding seal is disposed entirely against an outer surface of the electrical conductor.

24. The electrical terminal assembly of claim 1, wherein the expanding seal includes two inner ribs and two outer ribs; and a width of the inner ribs is less than a width of the outer ribs.

25. The electrical terminal assembly of claim 1, including a connector, wherein the expanding seal includes a radially extending rib and a neck portion disposed at least partially outside of the connector; the radially extending rib contacts an inner surface of the connector; and the neck portion is connected with the rib.
